(19) United States
(12) Patent Application Publication
(10) Pub. No.: US 2017/0140357 A1
(43) Pub. Date: May 18, 2017

(54) COMPUTER RESOURCE MANAGEMENT FOR MANUFACTURER AND RETAILER OFFERS

(71) Applicant: Target Brands, Inc., Minneapolis, MN (US)

(72) Inventors: Jay Matthew Fricke, Farmington, MN (US); Steven John Campbell, Maple Grove, MN (US); Jeffrey Patrick Nelson, Eden Prairie, MN (US); Ananth Ranganath, Minnetonka, MN (US); Kathryn Louise Morin, St. Paul, MN (US); Heidi Buehler TeWinkel, Hudson, WI (US)

(21) Appl. No.: 14/943,629

(22) Filed: Nov. 17, 2015

(51) Int. Cl. G06Q 20/20; G06Q 30/06; G06Q 20/38; G06Q 30/02; G06Q 20/32

(52) U.S. Cl. CPC G06Q 20/204; G06Q 30/0222; G06Q 30/0238; G06Q 20/3274; G06Q 20/387; G06Q 30/0641; G06Q 30/0625

(57) ABSTRACT

A method includes receiving information representing a first offer made by a manufacturer, wherein the first offer is related to a product. Information representing a second offer made by a retailer is also received, wherein the second offer is also related to the product. A request to display offers related to the product is received and in response, a user interface is generated that shows the first offer and the second offer. The user interface allows a retailer to set designations for the first offer and the second offer such that the first offer is available to customers and the second offer is not available to customers. A request from a customer for offers available at the retailer is received and in response the first offer but not the second offer is provided based on the designations set for the first offer and the second offer.

### BACKGROUND

Consumers are able to select coupons and other offers using the Internet and then redeem those offers at a physical store. For example, offers selected by the consumer over the Internet may be represented by one or more identifiers that can be displayed on the user's mobile device when the user is paying for their purchases. Such identifiers can be entered into the register to convey the offer information to the register and redeem the coupon offers.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes receiving information that represents a first offer made by a manufacturer and is related to a product. Information that represents a second offer made by a retailer that is also related to the product is also received. A request to display offers related to the product is received and in response, a user interface is generated that shows the first offer and the second offer. The user interface allows a retailer to set designations for the first offer and the second offer such that the first offer is available to customers and the second offer is not available to customers. A request from a customer for offers available at the retailer is received and in response the first offer but not the second offer is provided based on the designations set for the first offer and the second offer.

In accordance with a further embodiment, a server is provided that includes an offer database receiving offers made by manufacturers and offers made by a retailer. An offer management tool executed by a processor displays a user interface to allow a retailer to individually set offers in the offer database made by manufacturers as available and offers in the offer database made by the retailer as available. An offer application executed by the processor generates user interfaces that allow a customer to select an available offer made by a manufacturer such that after the offer is selected, the selected offer can be redeemed by the customer.

In accordance with a still further embodiment, a method includes storing offers made by a retailer in a database and receiving offers made by manufacturers over a network. The offers made by manufacturers are filtered to select fewer than all of the offers made by manufacturers and the selected offers are stored in the database. A first user interface is displayed to allow a retailer to designate which of the offers made by the retailer and which of the offers made by manufacturers are to be made available to customers. A second user interface is displayed that allows a customer to view offers made by the retailer and offers made by manufactures that are available to customers and to select a viewed offer for later redemption.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for managing manufacturer coupons and retailer coupons in accordance with one embodiment.

FIG. 2 is a flow diagram of a method of managing manufacturer coupons and retailer coupons.

FIG. 3 provides an example user interface of an offer management tool showing search results for an offer query.

FIG. 4 provides an example of a user interface showing details of a manufacturer's offer.

FIG. 5 provides an example user interface showing details of a retailer's offer.

FIG. 6 provides a user interface of the offer management tool after a manufacturer's offer and a retailer's offer have been modified.

FIG. 7 provides an example user interface that allows a customer to view available offers.

FIG. 8 provides an example user interface allowing a customer to select an offer.

FIG. 9 provides an example user interface showing selected offers before redemption of a manufacturer's offer.

FIG. 10 provides a flow diagram of a method of redeeming manufacturer and retailer offers.

FIG. 11 an example user interface showing selected offers after redemption of the manufacturer's offer.

FIG. 12 shows a block diagram of an exemplary computing device.

### DETAILED DESCRIPTION

A number of different web sites and mobile applications exist that allow customers to search for coupons or other offers for products. Each site or application includes its own collection of such offers. As a result, customers tend to access multiple web sites or use multiple applications to find as many offers as possible.

This has created an inefficient system where customers are submitting the same queries multiple times to multiple different web sites and/or applications. Further, the offers that are selected from different web sites or applications are stored separately from each other. As a result, at checkout, the customer must access multiple locations to retrieve the identifiers for the offers that are being redeemed. This slows down the checkout process and results in retailers having to hire additional employees to run additional registers so that the total wait time for checking out does not increase.

In addition, since not all products are available at a particular retail store, many of the offers selected by the customer cannot be redeemed at the store where the customer intends to shop. As a result, the customer has wasted their time and the computing resources of the servers that provide the web sites and mobile applications.

The current technology also does not provide any tools that allow a retailer to select between a manufacturer's offer and a retailer's offer when establishing a set of offers that customers can search and select from and as a result, both manufacturer and retailer offers are returned in response to search queries. This causes delays in how quickly the offer server can respond to queries because the offer server sends back data for both manufacturer offers and retailer offers on the same product, which takes longer to send than just sending back data for the manufacturer offer or just sending data back for the vendor offer. While this delay may be insignificant on a small scale, when large numbers of customers are accessing an offer server, such as on the day after Thanksgiving, the delays can be significant and can result in a denial of service for some customers.

In the embodiments described below, manufacturer offers are located and then filtered to remove offers for products that are not available at a particular retailer. The remaining manufacturer offers are stored in a database together with retailer offers. Availability settings for the manufacturer offers and the retailer offers are controlled through an offer management tool such that if there are two offers for a product, one of the offers can be made available for selection by the customer while the other offer is made unavailable. To minimize the screen space occupied by each offer and thus maximize the number of offers shown on a single display screen, information that distinguishes retailer offers from manufacturer offers is not displayed when showing multiple offers on the screen.

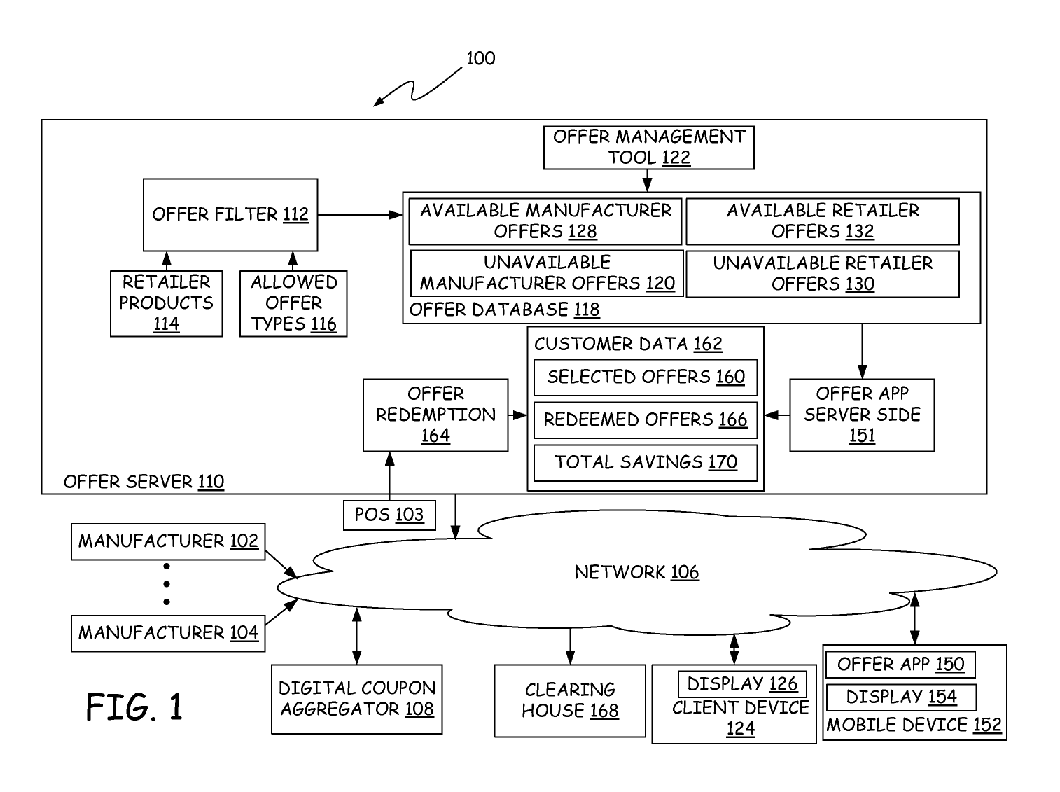

FIG. 1 provides a block diagram of a system 100 for managing an offer server that provides manufacturer and retailer offers in accordance with one embodiment. In system 100, a plurality of manufacturers, such as manufacturers 102 and 104 provide digital information through a network 106 to a digital coupon aggregator 108. The digital information includes descriptions of manufacturer coupons/offers. This information can include an identification of the type of offer, the amount of savings associated with the offer, an identifier for the offer and a listing of products that the offer can be redeemed against. Digital coupon aggregator 108 aggregates the offer information from the plurality of manufacturers to generate an offer file that is transmitted through network 106 to an offer server 110.

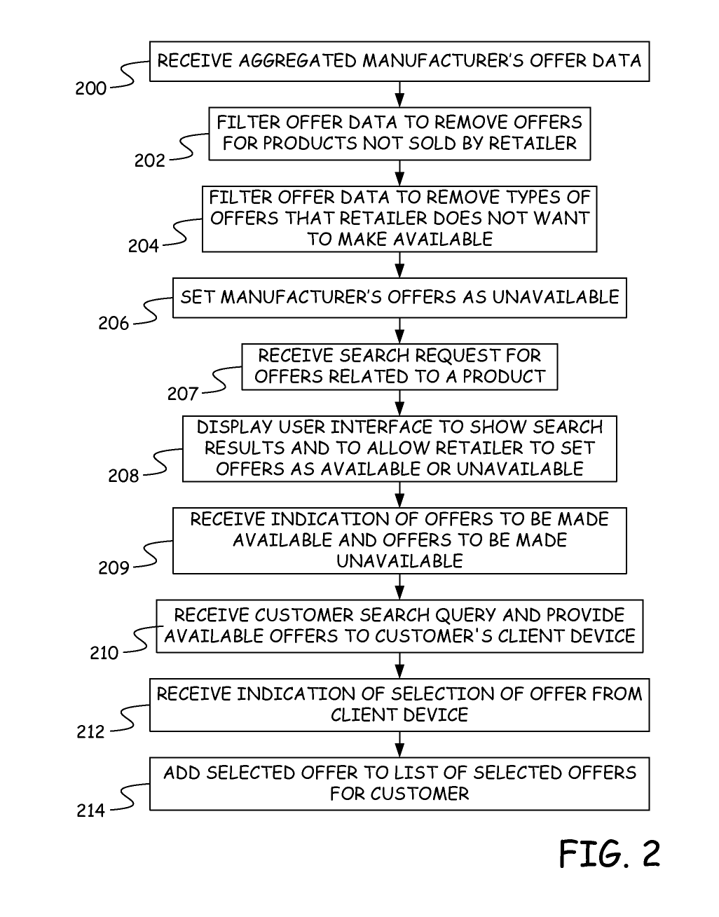

FIG. 2 provides a flow diagram of steps performed by offer server 110 to manage the operation of the server so that delays in responding to queries are reduced. At step 200, offer server 110 receives the aggregated manufacturer offer information from digital coupon aggregator 108.

At step 202, offer server 110 applies the aggregated manufacturer offer information to an offer filter 112. In step 202, offer filter 112 removes offer information for offers on products that a retailer does not sell. Offer filter 112 can remove such offer information based on retailer products 114, which is a list of product identifiers for products sold by the retailer. If a manufacturer's offer cannot be redeemed against at least one product identified in retailer products 114, the offers informatoin is removed by offer filter 112. For example, if the manufacturer's offer is for Brand A detergent but the retailer does not carry Brand A products, the manufacturer's offer would be removed by offer filter 112.

At step 204, offer filter 112 removes offer information for manufacturer offers that are of a type that the retailer does not want to make available. Offer filter 112 removes these offers based on allowed offer types 116 that are stored in a memory of offer server 110. Thus, if an offer type is not in the listed allowed offer types 116, offer filter 112 removes the offer information for that offer. For example, if the retailer does not want to allow Buy One Get One manufacturer offers, offer filter 112 will remove the offer information for such offers at step 204.

Steps 202 and 204 improve the operation of offer server 110 by reducing the amount of memory needed to store offer database 118. In particular, by removing offers for products that are not sold by the retailer and removing offers that are of a type that the retailer does not support, the size of the memory needed for offer database 118 can be reduced. In addition, by removing these offers, the customer will not select offers that cannot be redeemed at the retailer, thereby reducing the amount of time and computing resources that the customer uses.

The manufacturer's offers that are not removed by offer filter 112 are stored in an offer database 118 as unavailable manufacturer offers 120 at step 206. Unavailable manufacturer offers 120 are offers that have been selected for inclusion in the offer system but that have an availability setting that has been set to unavailable such that customers will not receive the offers in response to search queries. As described further below, the availability setting of the manufacturer offers can be changed by the retailer to convert the offer from an unavailable manufacturer offer 120 to an available manufacturer offer 128. Since manufacturer offers are made unavailable when first added to offer database 118, a manufacturer's offer does not increase the bandwidth required for responding to customer queries for offers when it is first received from digital coupon aggregator 108.

At step 207, an offer management tool 122 in offer server 110 provides a user interface to a client device 124, which allows a retailer to enter a search query for offers through a display 126. The search query is received by offer management tool 122 and is used by offer management tool 122 to search unavailable manufacturer offers 120, available manufacturer offers 128, unavailable retailer offers 130 and available retailer offers 132. At step 208, offer management tool 122 displays a user interface that shows the results of the search query and that allows the retailer to set offers in the search results as either available or unavailable. For example, the user interface displayed at step 208 allows the retailer to use client device 124 to set manufacturer offers as available while setting retailer offers as unavailable.

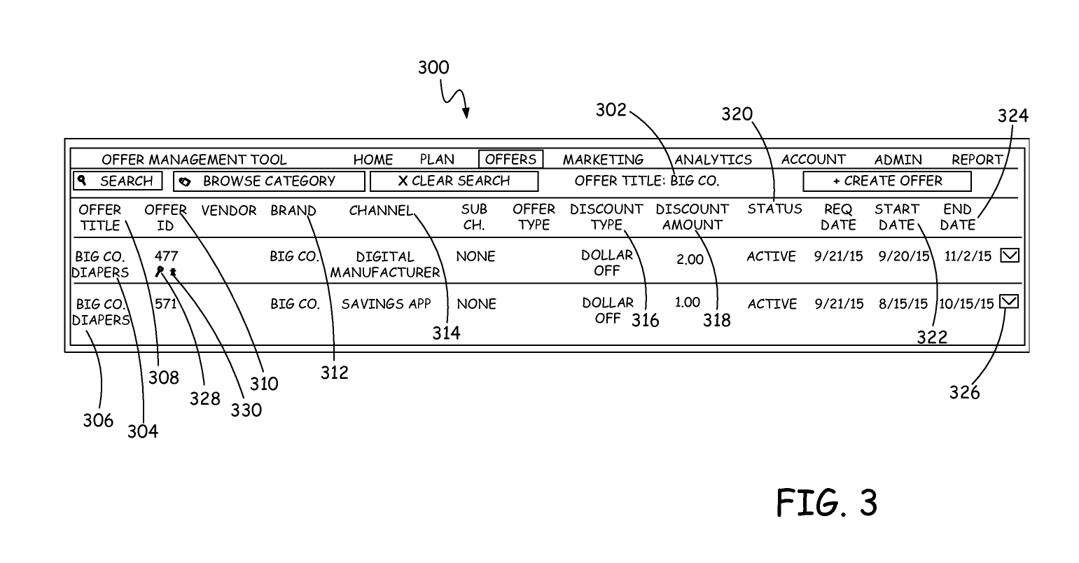

FIG. 3 provides an example user interface 300 produced during step 208 in accordance with one embodiment. User interface 300 includes a search criteria 302 of “Offer Title: Big Co.”, which indicates that the search is within the field “Offer Title” and the search is for the phrase “Big Co.” User interface 300 also includes two rows of results 304 and 306 with each row representing a separate offer that meets the search criteria. Each result includes an offer title 308, an offer ID 310, a brand identifier 312, a channel 314, a discount type 316, a discount amount 318, a status 320, a start date 322, an end date 324 and a pull down control 326. Channel 314 indicates whether an offer is made by a manufacturer, such as the offer of result 304 or is made by a retailer and is part of a savings application generated by the retailer as found in result 306.

User interface 300 also includes availability icons, such as Removed from Browse icon 328 and Hidden icon 330. When a result, such as search result 304 is shown with Hidden icon 330, it means that the offer will not appear in any browsing results returned to a customer but if the customer has a URL for the offer, the customer can add the offer to the list of offers selected by the customer. Removed from Browse icon 328 indicates that an offer is not available to the customer and thus the offer will not appear in any browsing results when the customer is looking for offers to select.

In FIG. 3, the availability icons in result 304 indicate that the corresponding manufacturer's offer is not available to customers while the lack of availability icons in result 306 indicates that the corresponding retailer offer is available to customers.

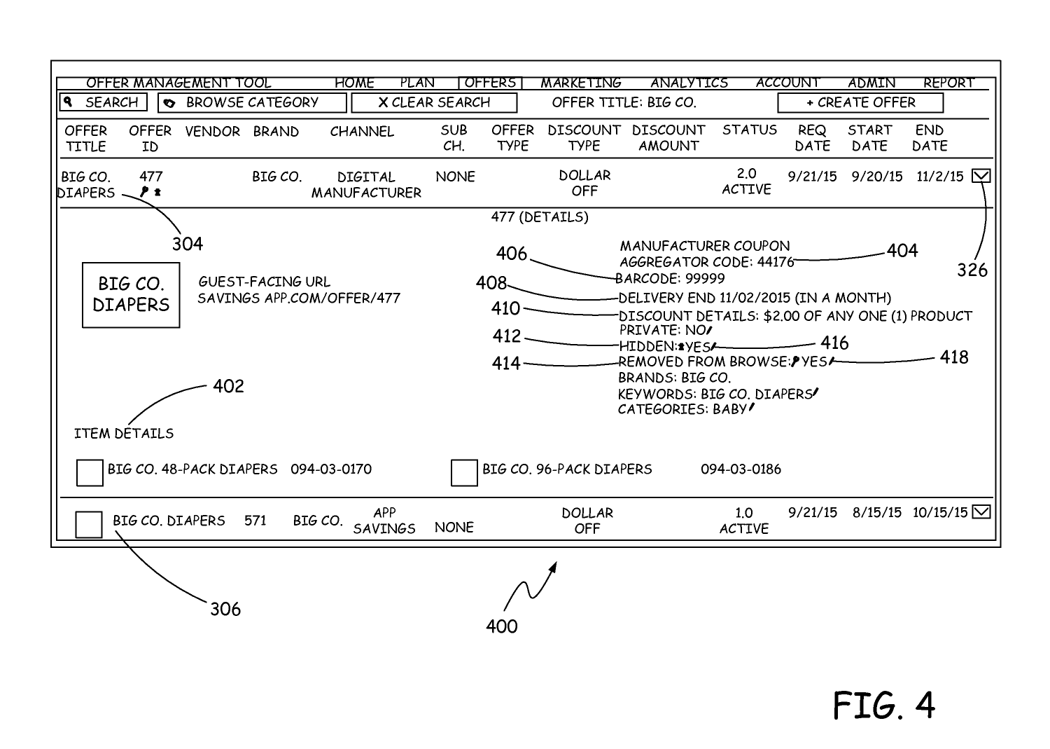

Pull down controls 326 of user interface 300 allow the retailer to set the availability of respective offers. Thus, at step 208, user interface 300 can be used to set the manufacturer's offer of result 304 as available and set the retailer offer of result 306 as unavailable. For example, when pull down control 326 of offer result 304 is activated, user interface 300 of FIG. 3 is altered to form user interface 400 of FIG. 4.

In user interface 400, details window 402 for offer result 304 has been opened below offer result 304. The details for the offer include an aggregator code 404 that is provided by digital coupon aggregator 108, a bar code 406 that uniquely identifies the manufacturer's coupon, an end date 408 for the offer and discount details 410, which describes the type of discount and the amount of discount. Details window 402 also includes a hidden indicator 412 and a removed from browse indicator 414 that correspond with Hidden icon 330 and Removed from Browse icon 328, respectively. An edit control 416 can be selected by a retailer to toggle hidden indicator 412 and an edit control 418 can be selected by the retailer to toggle removed from browse indicator 414.

If hidden indicator 412 is set to “no” using edit control 416, while removed from browse indicator 414 is set to “yes”, customers will not be able to add the offer to a set of selected offers and the offer will not appear in any search results. If hidden indicatory 412 is set to “yes” and removed from browse availability 414 is set to “no”, the offer will not appear in any offer search results for the customer but the customer can add the offer to a set of selected offers if the customer knows the URL of the offer. If both hidden indicator 412 and removed from browse indicator 414 are set to “no”, the offer will appear in search results to the customer and the customer can add the offer by selecting the offer from the search results or by entering the offer's URL.

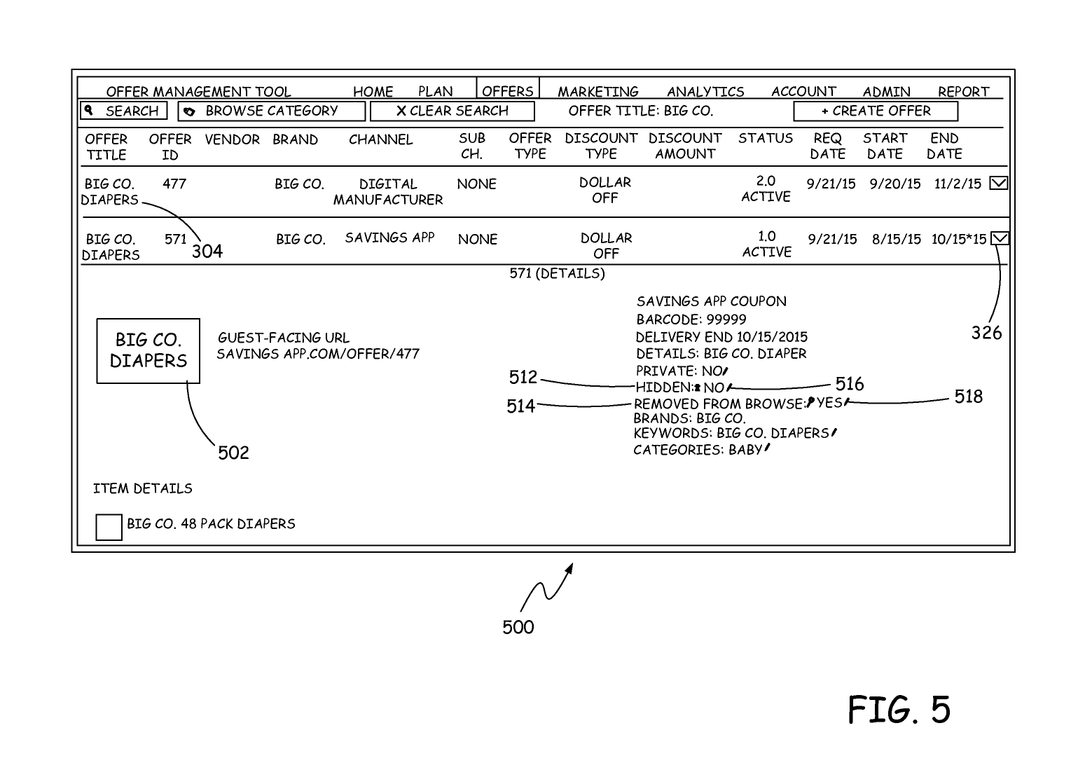

The availability of retail offer 306 can be set by opening a details window 502 using pull down control 326 of retail offer 306 as shown in user interface 500 of FIG. 5. Details window 502 is similar to details window 402 and includes a hidden indicator 512 and a removed from browse indicator 514 that can be altered using respective edit controls 516 and 518. As shown in user interface 500, retail offer 306 appears in search results provided to the customer since hidden indicator 512 is set to “no” and removed from browse indicator 514 is also set to “no”. Using controls 516 and 518, the retailer can change one or both of indicators 512 and 514 to “yes” and thereby keep retail offer 306 from appearing in search results provided to the customer.

At step 209, offer management tool 122 receives indications that one or more offers are to be made available to customers and/or one or more offers are to be made unavailable to customers. In response, offer management tool 122 updates offer database 118 to reflect the received availability settings. These settings determine whether a manufacturer's offer is an available manufacturer offer 128 or an unavailable manufacturer offer 120 and whether a retailer's offer is an available retailer offer 132 or an unavailable retailer offer 130. By changing these settings, offer management tool 112 improves the performance of offer server 110 by reduce the number of offers that are returned to customers based on searches for offers, thereby reducing the amount of bandwidth used by offer server 110 and the amount of time required to return offers to the customer.

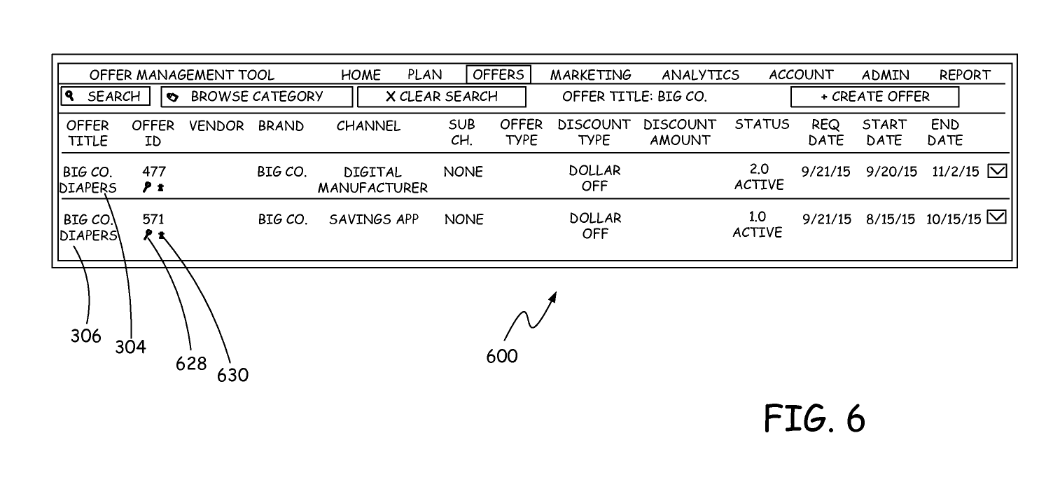

FIG. 6 provides an example user interface 600 showing the state of manufacturer's offer result 304 and retailer's offer result 306 after the availabilities of those offers have been changed at step 209. In particular, availability icons 328 and 330 for manufacturer's offer result 304 have been removed indicating that the manufacturer's offer for offer result 304 is now available for customers to select while hidden icon 630 and removed from browse icon 628 have been added to offer result 306 to indicate that the retailer offer associated with offer result 306 will not appear in any search results provided to the customer.

At step 210, an offer app 150 operating on a mobile device 152 submits a search request for available offers through network 106 to offer app server side 151 in offer server 110. Offer app server side 151 uses the search criteria, if any, provided by offer app 150 to search offer database 118 for available manufacturer offers 128 and available retailer offers 132 that meet the search criteria. Offer app server side 151 then provides the matching available offers to offer app 150 on mobile device 152. In response, offer app 150 displays the available offers in a user interface on a display 154 of mobile device 152.

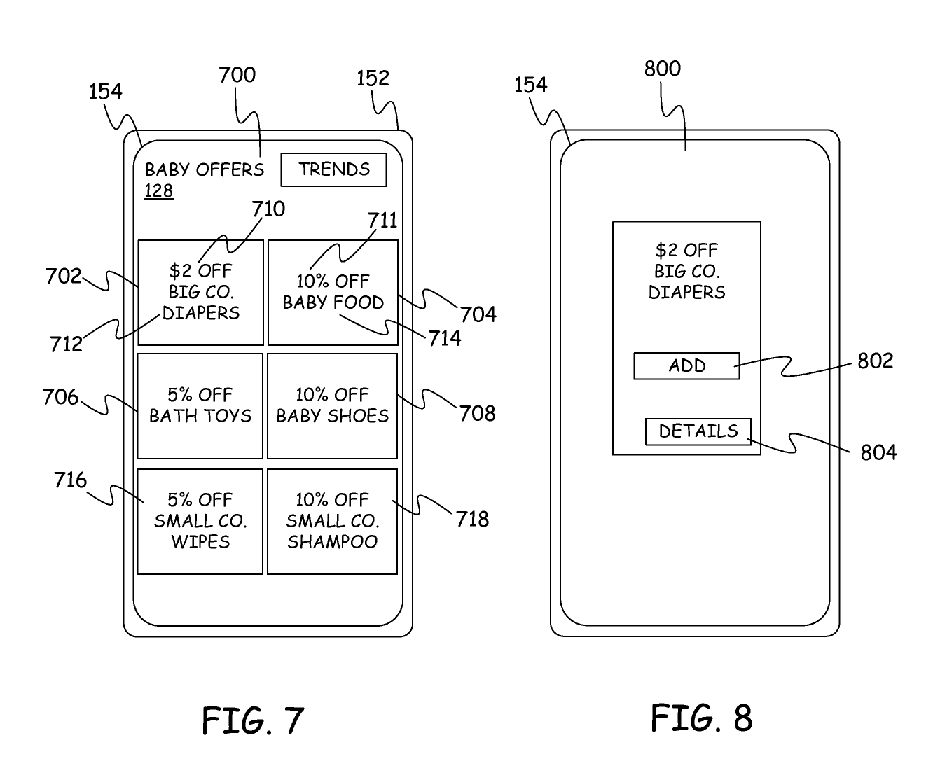

FIG. 7 provides an example user interface 700 generated on display 154 of mobile device 152 showing available offers returned by offer app server side 151. The offers include manufacturer offer 702 and retailer offers 704, 706 and 708, 716 and 718. Each of offers 702, 704, 706, 708, 716 and 718 is represented by a rectangular icon that includes discount information such as discount information 710 and 711 of offers 702 and 704 and product information, such as product information 712 and 714 of offers 702 and 704. As shown in FIG. 7, the displayed icons for manufacturer offers are indistinguishable from the displayed icons for retailer offers such that the displayed icons do not indicate if the offer is made by a manufacturer or by a retailer. Thus, the displayed icons for the offers do not indicate the source of the offer. This is done to minimize the amount of information displayed for each offer and thereby maximize the number of offers that can be displayed at the same time. Making the manufacturer offers indistinguishable from the retailer offer also improves the usability of the user interface by not forcing the customer to evaluate why some offers appear different from other offers. In most cases, the customer does not care if the offer comes from a retailer or from a manufacturer.

Each of the offer icons 702, 704, 706, 708, 716 and 718 is selectable and when selected causes an offer selection user interface to be displayed. For example, selections of manufacturer offer 702 causes user interface 800 of FIG. 8 to be displayed, which allows the customer to add offer 702 to a set of selected offers for the customer using add control 802. If the customer wishes to view details about the offer, they can select details control 804 before selecting add control 802.

When a customer selects add control 802, offer app server side 151 on offer server 110 receives the indication of the selection of the offer from mobile device 152 at step 212 and in response adds the selected manufacturer's offers to a list of selected offers 160 that are stored as part of customer data 162 for the customer at step 214.

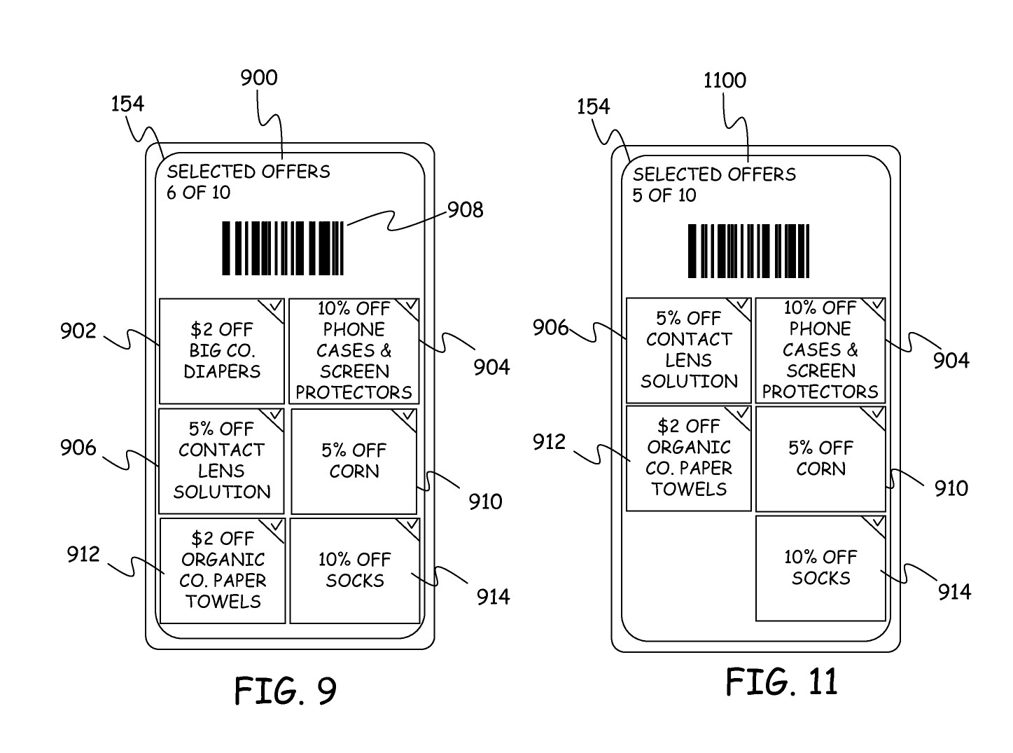

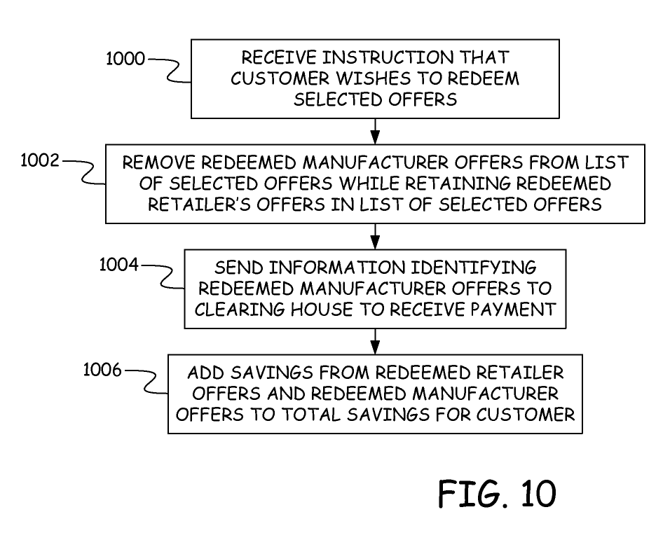

FIG. 9 provides an example of a user interface 900 on display 154 of mobile device 152 that shows a list of selected offers including a selected manufacturer offer 902 and selected retailer offers 904, 906, 910, 912 and 914. Customers may use user interface 900 to redeem offers when making a purchase at a point-of-sale register 163. In particular, the offers can be redeemed by having a scanner at point-of-sale register 163 scan barcode 908 of user interface 900. FIG. 10 provides steps that are performed when barcode 908 is scanned.

In particular, at step 1000, an offer redemption service 164 on offer server 110 receives an indication that a customer wishes to redeem selected offers 160 by receiving the information represented by barcode 908 from point-of-sale register 163. Using this barcode information, offer redemption service 164 accesses customer data 162 to retrieve selected offers 160. Offer redemption service 164 then compares the selected offers against the products being purchased at point-of-sale register 163 and for each offer that matches a purchased product, offer redemption service 164 adds the offer to a set of redeemed offers 166 for the customer. At step 1002, offer redemption service 164 removes any redeemed manufacturer's offers from selected offers 160 while retaining redeemed retailer's offers in selected offers 160. Thus, retailer offers can be used multiple times while manufacturer's offers can only be used once.

At step 1004, offer redemption service 164 sends information identifying the redeemed manufacturer's offer to a clearing house 168 through network 106. Clearing house 168 validates the identifier for the manufacturer's offer and remits payment to the retailer based on the manufacturer's offer. Thus, the retailer is reimbursed by the manufacturer for the redemption of the offer.

At step 1006, offer redemption service 164 adds the savings for all the redeemed retailer offers and redeemed manufacturer's offer to the total savings 170 of the customer. Thus, the savings provided by both manufacturer's offers and retailer's offers that are redeemed by the customer are included in total savings 170.

FIG. 11 provides an example of a user interface 1100 on display 154 of mobile device 152 after the customer has redeemed the offers shown in FIG. 9. As shown in FIG. 11, the redemption of manufacturer offer 902 has caused offer 902 to be removed from the selected offers of user interface 1100 while retailer offers 904, 906, 910, 912, and 914 remain on the user interface of selected offers. By automatically removing the redeemed manufacturer offers while retaining the redeemed retailer offers, the embodiments reduce the burden on the customer to remember which offers can be redeemed multiple times and which offers can only be redeemed once.

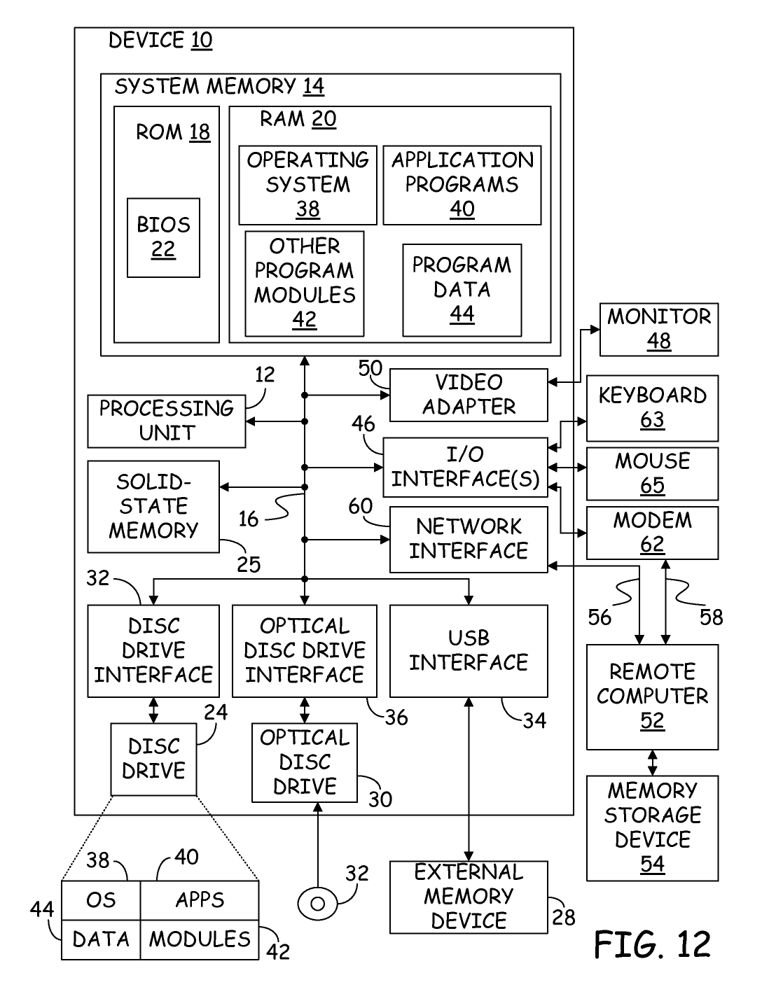

FIG. 12 provides an example of a computing device 10 that can be used as a server device or client device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing offer server 110 including programs for implementing offer filter 112, offer app server side 151, offer management tool 122 and offer redemption service 164. Program data 44 may include data such as retailer products 114, allowed offer types 116, available manufacturer offers 128, unavailable manufacturer offers 120, available retailer offers 132, unavailable retailer offers 130, and customer data 162, for example.

Processing unit 12, also referred to as a processor, executes programs in system memory 14 and solid state memory 25 to perform the methods described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 12. The network connections depicted in FIG. 12 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 12 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving information over a network, the information representing a first offer made by a manufacturer, wherein the first offer is related to a product;
receiving information representing a second offer made by a retailer, wherein the second offer is related to the product;
receiving a request to display offers related to the product;
in response to the request, generating a user interface that shows the first offer and the second offer, the user interface allowing a retailer to set designations for the first offer and the second offer such that the first offer is available to customers and the second offer is not available to customers; and
receiving a request from a customer for offers available at the retailer and in response providing the first offer but not the second offer based on the designations set for the first offer and the second offer.

2. The method of claim 1 wherein receiving information representing the first offer comprises applying the information to a filter that removes information for offers related to products that are not sold by the retailer.

3. The method of claim 1 wherein receiving information representing the first offer comprises applying the information to a filter that removes information for offers related to types of offers that the retailer does not permit from manufacturers.

4. The method of claim 1 further comprising:
receiving an indication that the customer has selected a plurality of offers and in response storing the selected offers;
receiving a further indication that the customer has redeemed a selected offer made by a manufacturer and has redeemed a selected offer made by the retailer; and
removing the redeemed offer made by the manufacturer from the stored selected offers while retaining the redeemed offer made by the retailer in the stored selected offers.

5. The method of claim 4 wherein in response to receiving an indication that the customer has redeemed a selected offer made by a manufacturer and has redeemed a selected offer made by the retailer, a total savings value for the customer is increased to include the savings from the redeemed offer made by the manufacturer and the redeemed offer made by the retailer.

6. The method of claim 4 wherein the customer redeems the selected offer made by the manufacturer and the selected offer made by the retailer by having a single barcode on a mobile device scanned at a point of sale register.

7. The method of claim 1 wherein providing the first offer comprises generating an icon for the first offer such that a source of the offer is not apparent from the icon.

8. A server comprising:
an offer database receiving offers made by manufacturers and offers made by a retailer;
an offer management tool executed by a processor to display a user interface to allow a retailer to individually set offers in the offer database made by manufacturers as available and offers in the offer database made by the retailer as available; and
an offer application executed by the processor to generate user interfaces that allow a customer to select an available offer made by a manufacturer such that after the offer is selected, the selected offer can be redeemed by the customer.

9. The server of claim 8 wherein the offer management tool is executed by the processor to provide a user interface that displays all offers associated with a product and to allow the retailer to set offers that are made by the manufacturer of the product as available while setting offers that are made by the retailer of the product as unavailable.

10. The server of claim 8 further comprising a filter executed by the processor to remove some offers made by manufacturers from the offer database.

11. The server of claim 10 wherein the filter removes offers made by manufacturers for products that are not sold by the retailer.

12. The server of claim 11 wherein the filter further removes offers made by manufactures that are of a type that the offer application does not allow the customer to select when the offer is made by a manufacturer.

13. The server of claim 8 wherein the offer application generates a user interface that shows an icon for each offer, wherein the icons do not indicate if the offer is made by a manufacturer or made by a retailer.

14. The server of claim 8 wherein the offer application further provides a user interface with a barcode such that scanning the barcode causes both offers made by manufacturers and offers made by the retailer to be redeemed.

15. A method comprising:
storing offers made by a retailer in a database;
receiving offers made by manufacturers over a network;
filtering the offers made by manufacturers to select fewer than all of the offers made by manufacturers and storing the selected offers in the database;
displaying a first user interface to allow a retailer to designate which of the offers made by the retailer and which of the offers made by manufacturers are to be made available to customers; and
displaying a second user interface that allows a customer to view offers made by the retailer and offers made by manufactures that are available to customers and to select a viewed offer for later redemption.

16. The method of claim 15 wherein filtering the offers comprises removing offers for products that are not sold by the retailer.

17. The method of claim 15 wherein filtering the offers comprises removing certain types of offers.

18. The method of claim 15 wherein displaying the first user interface comprises receiving a request for offers related to a product name, retrieving an offer made by the retailer and an offer made by a manufacture for a product containing the product name, and displaying the offer made by the retailer and the offer made by the manufacturer for the product containing the product name.

19. The method of claim 18 further comprising receiving input from the user to designate the offer made by the manufacturer as available and to designate the offer made by the retailer as unavailable.

20. The method of claim 15 wherein displaying the second user interface comprises displaying an icon for each offer wherein the source of the offer is not apparent from the icons.
